(19) United States
(12) Patent Application Publication
(10) Pub. No.: US 2015/0109459 A1
(43) Pub. Date: Apr. 23, 2015

(54) AUTOMATED QUALITY CONTROL OF AUDIO-VIDEO MEDIA

(71) Applicant: Amberfin Limited, Basingstoke (GB)

(72) Inventors: Tim Shuttleworth, Reading (GB); Bruce Devlin, Chiddingfold (GB)

(21) Appl. No.: 14/383,600

(22) PCT Filed: Mar. 11, 2013
(86) PCT No.: PCT/GB2013/050596

§ 371 Date: Sep. 8, 2014

(30) Foreign Application Priority Data
Mar. 9, 2012 (GB) 1204221.4

(51) Int. Cl. H04N 17/00

(52) U.S. Cl. CPC H04N 17/00; H04N 2017/006
USPC 348/180

(57) ABSTRACT

In an audio-video process chain where measurements are taken between process stages, each measurement is converted to a threshold confidence by normalizing where required and comparing with a threshold value of acceptability taking into account the latitude of acceptability associated with that threshold and an error function relating to the reliability of the measurement. That threshold confidence extends linearly between a value denoting certainty of acceptability and a value denoting certainty of unacceptability.

### CROSS-REFERENCE TO RELATED APPLICATIONS

This application is a US National Phase of PCT/GB2013/050596, filed on Mar. 11, 2013, which claims priority to GB 1204221.4, filed on Mar. 9, 2012, incorporated herein by reference in their entirety.

### BACKGROUND OF THE INVENTION

1. Field of the invention

This invention relates to automated or part automated quality control of audio-visual media.

2. Description of the Related Art

There is a need to ensure that the quality of audio-visual media meets appropriate criteria for its commercial sale and distribution. The criteria are usually expressed in the form of tests that comprise measurements resulting in value that have to fall within thresholds. There are many automated tools that are able to perform computations on the media in order to generate the value for these measurements. These automated measurements are usually calibrated by means of subjective testing or by correlating the results against known good and bad material.

For any given measurement, a particular operation will set its threshold on the value of that measurement to a level that is appropriate for that operation. Operations that make or distribute quality movies are likely to have thresholds that are significantly higher than those that are set—for example—by operations that distribute user generated content on the Internet. It is common for higher quality content to be re-purposed for delivery through lower quality delivery channels. For these and other reasons, it would be advantageous if methods and apparatus for quality assessment of audio-visual media could be provided which offer both the flexibility to meet different business needs and the consistency to set standards of quality acceptable across a range of—possibly conflicting—business interests.

There exist a variety of automated quality assessment tools that measure aspects of audio or video quality. However, despite extensive testing by the measurement tool vendors, there still remains significant margin for error in the values resulting from some measurements. These errors may result in:
False Positives. These errors result in a piece of material being marked as acceptable when, in fact, a human operator would have judged the material to have failed the test. An example of this might be a blockiness measure where the level of blockiness is very low, but the position of the blockiness obscures some critical text on the screen. The blockiness measure would not have triggered because the measure itself did not take into account that certain parts of the screen were more critical to the viewer than others.
False Negatives. These errors result in a piece of material being marked as a failure when, in fact, a human operator would have judged the material to have passed the test. An example of this might be a blockiness measure applied to a music video where a special “blockiness” effect was applied to the picture for creative reasons. The blockiness measure would be triggered, but the measurement tool has no independent way of knowing that blockiness was part of the creative intent.
Different results from different measurement vendors. Most of the automated measurements used in the industry are not standardized to a level where consistent pass/fail results are possible between different vendors. Many measurement vendors adapt their measures to include extra intelligence, filtering, motion compensation or other techniques to gain an edge in the market place. This means that it is very difficult for a media company to compare results from vendors without using expensive and highly trained staff to interpret results. In a high volume “media manufacturing” environment, this is often impractical.
Increased failure rates from the creative-intent of the media. Media files are, by definition, intended for human consumption as entertainment. Audiences like to be surprised, so media often contains content that surprises humans and measurement tools. For example a sequence that becomes black and white for a brief period would trigger a “black and white” measuring tool. In a media file that contained video shot in colour, this would be a surprising result and should be categorized as an error unless specific knowledge about the media was communicated to the measurement system. This knowledge would for example mark “black and white content is ok between 10 minutes and 15 minutes in the file”.

While the disadvantages of any specific automated measurement tool can usually be overcome through operator involvement, it is not viable economically to involve operators at each stage of an audio-video delivery chain or within each involved business.

### SUMMARY OF THE INVENTION

It is an object of embodiments of the present information to overcome or ameliorate some or all of these disadvantages.

Accordingly, the present invention includes in one aspect in apparatus for monitoring the quality of an audio-video process chain comprising a plurality of processes operating in stages on audio-video content, the apparatus comprising a plurality of measurement tool interfaces for connection with measurement tools to receive measurements; and a confidence threshold processor for converting each measurement to a threshold confidence; wherein the confidence threshold processor receives the measurement, a threshold value of acceptability; a latitude of acceptability relating to the threshold; and an error function relating to the reliability of the measurement; the confidence threshold processor being configured such that the threshold confidence extends linearly between a value denoting certainty of acceptability and a value denoting certainty of unacceptability. A graphical user interface may include a linear graphical representation of each threshold confidence.

In another aspect, the present invention includes in a method of controlling an audio-video process chain comprising a plurality of processes operating in stages on audio-video content, the method comprising the steps of: taking in respective measurement tools a plurality of measurements; in a processor, converting each measurement to a threshold confidence by normalizing where required and comparing with a threshold value of acceptability taking into account the latitude of acceptability associated with that threshold and an error function relating to the reliability of the measurement, such that the threshold confidence extends linearly between a value denoting certainty of acceptability and a value denoting certainty of unacceptability; defining pass and fail ranges of values of the threshold confidence; storing for delivery or further processing audio-video content having a threshold confidence within the pass range; and rejecting audio-video content having a threshold confidence within the fail range. A warn range of values of the threshold confidence may be defined between and contiguous with the pass and fail ranges and content having a threshold confidence within the warn range may be diverted for reworking.

In another aspect, the present invention includes a method of monitoring the quality of an audio-video process chain comprising a plurality of processes operating in stages on audio-video content, the method comprising the steps of taking a plurality of measurements M_{g,n,s} where #g denotes the measurement group, #n denotes the measurement tool employed in taking the measurement and #s denotes the processing stage at which the measurement is taken; converting each measurement M_{g,n,s} to a threshold confidence TC_{g,n,s} by normalizing where required and comparing with a threshold value of acceptability taking into account the latitude L_{g,s} of acceptability and an error function EB_{g,n,s} relating to the reliability of the measurement M_{g,n,s} such that the threshold confidence TC_{g,n,s} extends linearly between a value denoting certainty of acceptability and a value denoting certainty of unacceptability.

Preferably the method further comprises providing at a first process stage for an operator viewing the audio-video content to input an Override Confidence OC_{g,n,s} to override the threshold confidence TC_{g,n,s}; and, at a second subsequent process stage, electing automatically whether to override the threshold confidence TC_{g,n,s} with the previous Override Confidence OC_{g,n,s} based on the second stage measurement M_{g,n,s}.

In the case of an operator inputting an Override Confidence OC_{g,n,s}, the overridden threshold confidence TC_{g,n,s} and its associated normalised measurement value N_{g,n,s} may be made available in subsequent process stages.

Pass and fail ranges of values of the threshold confidence TC_{g,n,s} may be defined. The method may suitably comprise the steps of approving and/or storing for delivery or further processing audio-video content having a threshold confidence TC_{g,n,s} within the pass range and rejecting audio-video content having a threshold confidence TC_{g,n,s} within the fail range.

Pass, warn and fail ranges of values of the threshold confidence TC_{g,n,s} may be defined. The method may suitably comprise the steps of approving and/or storing for delivery or further processing audio-video content having a threshold confidence TC_{g,n,s} within the pass range; diverting for reworking audio-video content having a threshold confidence TC_{g,n,s} within the warn range and rejecting audio-video content having a threshold confidence TC_{g,n,s} within the fail range.

A collection of audio-video content may be ranked in accordance with the threshold confidence TC_{g,n,s} and reworking resource is allocated to audio-video content within the collection in dependence upon the ranking.

TC_{g,n,s} is represented in the embodiment of this invention by a number between 0 and some maximal value (for example between TCₘᵢₙ=0 and TCₘₐₓ=100%). The value 0 represents a certainty that the measured value represents an error and TCₘₐₓ represents certainty that the measured value represents a pass. Calculation of values of TC are system dependent but can be represented by the following representation:

TC_{g,n,s}=C_{g}(N_{g,n,s}, EB_{g,n,s}, TV_{g,s}, L_{g,s})

where N_{g,n,s} is a normalised measurement value, TV_{g,s} is a threshold value denoting pass/fail, EB_{g,n,s} is an error bar function that denotes the statistical uncertainty of that measurement type and C_{g} is a confidence mapping function that converts normalised measurement values of the given measurement type to a linearly, monotonic threshold confidence value based on that measurement's properties.

The latitude L_{g,s} denotes the tolerance of a measurement to the threshold and may vary between process stages. Threshold confidence TC_{g,n,s} values for all tools in the same measurement group may be aggregated at each process stage. The result is an overall threshold confidence for that group. An example of this is the application of different loudness tools to a piece of music that has undergone processing. The answer the business question “Is the music too loud and has the music always been too loud?” can be answered by inspecting the threshold confidence for a group of loudness measurements spanning the processes the music underwent in a facility.

The present invention includes in another aspect in a method of monitoring the quality of an audio-video process chain comprising a plurality of processes operating in stages on audio-video content, the method comprising the steps of taking a plurality of measurements comprising at least a first measurement at a first process stage and at least a second measurement at a second process stage measurement; generating for each measure an error function which is monotonically related to the expected error of the measurement and combining the error function with the measure to form a measurement range; providing at a first process stage for an operator viewing the audio-video content to override the first measure with a first operator override; and, at a second subsequent process stage, automatically overriding the second measurement with the first operator override if the second measurement range overlaps the first measurement or overlaps the first operator override.

The present invention includes in still another aspect in apparatus for monitoring the quality of an audio-video process chain comprising a plurality of processes operating in stages on audio-video content, the apparatus comprising a plurality of measurement tool interfaces for connection with measurement tools to receive measurements M_{g,n,s} where #g denotes the measurement group, #n denotes the measurement tool employed in taking the measurement and #s denotes the processing stage at which the measurement is taken; and means for converting each measurement M_{g,n,s} to a threshold confidence TC_{g,n,s} by normalizing where required and comparing with a threshold value of acceptability taking into account the latitude L_{g,s} of acceptability and an error function EB_{g,n,s} relating to the reliability of the measurement M_{g,n,s} such that the threshold confidence TC_{g,n,s} extends linearly between a value denoting certainty of acceptability and a value denoting certainty of unacceptability.

The apparatus may further comprising an operator override input enabling an operator viewing the audio-video content to input an Override Confidence OC_{g,n,s} to override the threshold confidence TC_{g,n,s} and a graphical user interface including a linear graphical representation of the measurement M_{g,n,s} and/or each threshold confidence TC_{g,n,s}.

In the context of this invention the term audio-video content includes audio content; video content and audio-video content.

It will be seen that some embodiments of the invention provide a mechanism for storing and automatically propagating operator derived information in a way that enables the results of a media measurement tool to be trusted to a greater extent than hitherto.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

In the drawings:

FIG. 1 is a block diagram illustrating an embodiment of the invention:

FIGS. 2 and 3a-3c illustrate the lifecycle of a measurement;

FIGS. 4 and 5 illustrate the accumulation of measurement information as processes are applied to a piece of media;

FIG. 6 is a block diagram similar to FIG. 1, illustrating a further embodiment of the invention;

FIG. 7 illustrates multiple measurements at multiple stages of the lifecycle of some media;

FIG. 8 illustrates an enhancement on FIG. 7 that takes into account measurement inaccuracies;

FIG. 9 illustrates the handling of operator overrides; and

FIG. 10 is a block diagram illustrating constituent parts of a system according to one embodiment of the invention.

### DETAILED DESCRIPTION OF EMBODIMENTS OF THE INVENTION

Reference will now be made in detail to the preferred embodiments of the present invention, examples of which are illustrated in the accompanying drawings.

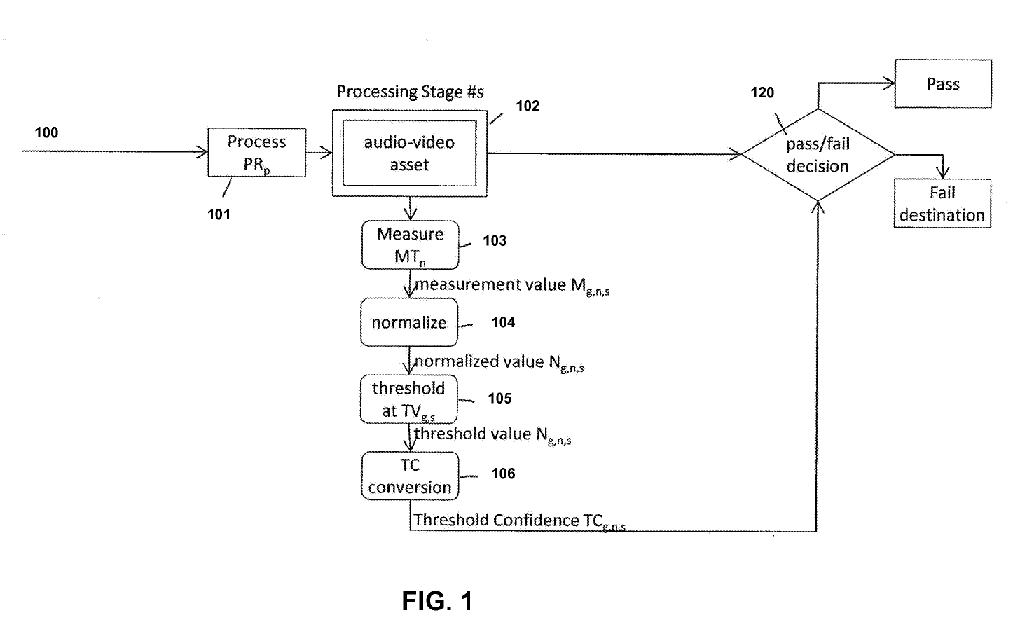

FIG. 1 is a block diagram illustrating a simplified arrangement according to the present invention. The skilled man will understand that the functionality depicted in FIG. 1 can be implemented in a wide variety of forms including dedicated hardware, programmable apparatus; software and appropriate combinations of the foregoing.

Audio-video content 100 is delivered to a processing block 101 providing process PRₚ. The audio-video content or asset 102 is then passed for storing or further processing or failed, in decision block 120.

A measurement tool 103 takes a measurement on the audio-video content 102 and that measurement is processed in blocks 103 to 106 (the functionality of which will be described in detail below) to control the decision block 120.

It will be helpful to define some terms used in the diagrams and texts:

PRₚ Process #p which operates on audio-video material

MTₙ Measurement Tool #n that comprises a number of discrete measurements. e.g. MT_{A} might be the Acme Testing Tool.

M_{g,n,s} Measurement performed by tool #n of measurement tool group #g at processing stage #s of a workflow, e.g. M3,A,1 and M3,A,2 and M3,A,3 are all the same type of measurement created with the same tool, but performed at different stages in the lifecycle of the material.

N_{g,n,s} Normalised Measurement in group #g from tool #n at stage #s.

TV_{g,s} Threshold Value for group #g at stage #s. This is the critical value that a Normalised Measurement must meet for a measurement to have “passed”.

TCg,n,s Threshold Confidence of Measurement #g implemented by tool #n and used at stage #s

L_{g,s} Latitude in the Threshold Value for group #g at stage #s. This controls the range of Threshold Values for which a Normalised Measurement will generate non-zero Threshold Confidence values.

EBg,n,s Error Bar function. A factor that controls the size of the error bars of a measurement in group #g of tool #n at stage #s.

OCg,n,s Override Confidence of a Measurement in group #g from tool #n at stage #s. This is the Confidence value given to an Override whether introduce manually by a human at a GUI or automatically via stored knowledge in, for example, a database.

ACg,n,s Auto-assigned Confidence of measurement in group #g, from tool #n at stage #s.

An explanation of the lifecycle of a measurement may be helpful in clarifying the relationship between the different terms is clear.

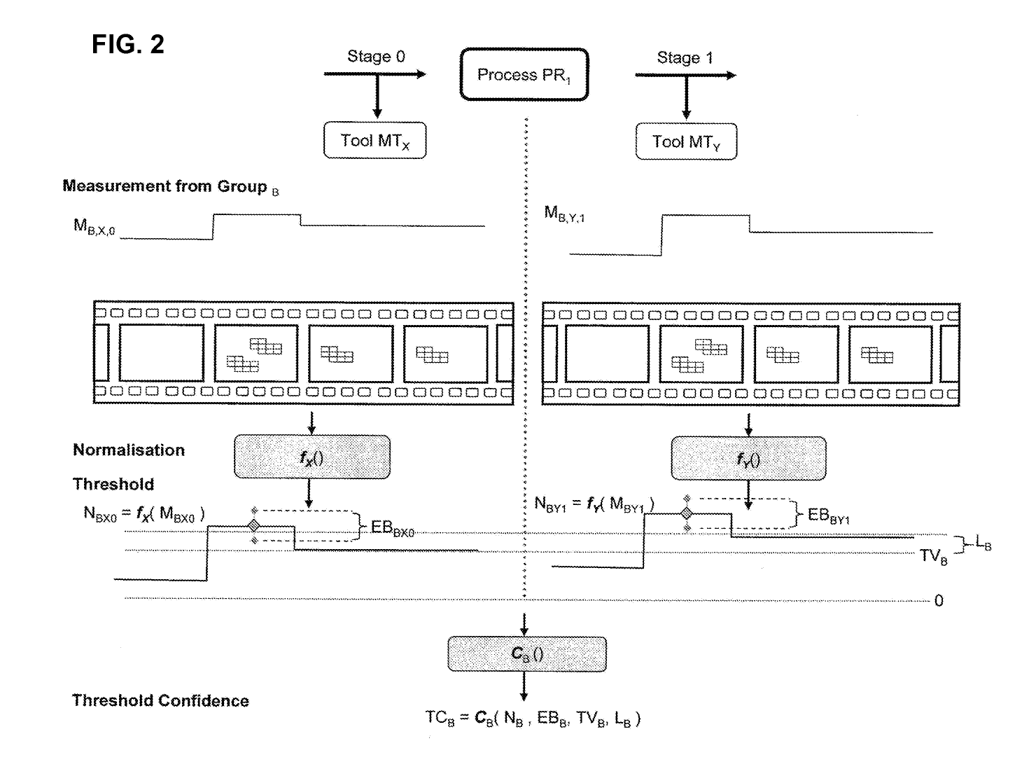

Referring to FIG. 2, a measure of video blockiness is taken before and after a transcode process PR₁. The measurement is being performed by a tool of the video-blockiness group MT_{B}. This group is identified in this example by the B subscript. Tools are categorised so that any tool within a group may have its Normalised Measurement Value compared with any other tool's Normalised Measurement within the group.

Define measurement M_{B,X,0} at stage 0 before Process PR₁ with tool MT_{X} from Group B.

Define measurement M_{B,Y,1} at stage 1 after Process PR₁ with tool MT_{Y} from Group B.

These measurements cannot be directly compared unless their units are normalised by some tool specific function that ensures their units, range and linearity are similar.

N_{B,X,0}=f_{X}(M_{B,X,0}) and N_{B,Y,1}=f_{Y}(M_{B,Y,1})

Where f_{X( )} and f_{Y( )} are the tool specific normalisation functions for Tools MT_{X} and MT_{Y}.

Now that there are comparable results, it is possible to compare the Normalised Value N_{g,n,s} to a Threshold Value TV_{g,s} to see if the measurement was within tolerance at that stage of the media's lifecycle. For simplicity in FIG. 2, the Threshold Values have been made identical and are shown as TV_{B}.

It is necessary to take into account the fact that many media measurements are inherently uncertain so there is a need to know the confidence that a result has exceeded a threshold. It should be noted that some Threshold Values are minimal in nature (e.g. to pass a test, all 8 bit pixel values should be greater than the decimal Threshold Value 16) and some Threshold Values are maximal in nature (e.g. all to pass a test, all 8 bit pixel values should be less than the decimal Threshold Value 235). The examples in this text will predominantly use the maximal threshold case. The same principles hold for the minimal threshold case.

There are two main elements of uncertainty that are taken into account in this method. The first is the Latitude L_{g,s} of a threshold in group #g at stage #s of a measurement. This property measures how much uncertainty can be tolerated at stage #s in the media lifecycle and is shown in FIG. 2 by the fine dashed line above the maximal Threshold Value TV_{B}.

In a simple system with a maximal Threshold Value, a Normalised Measurement N must be below some threshold to pass. From the example in FIG. 2, it can be seen that both the normalised measurement values are above the maximum Threshold Value and that they would both constitute a failure.

In a media system, many of these absolute Threshold Values are in practice somewhat arbitrary, so the present invention employs the concept of Threshold Confidence TC_{g,n,s}. The Normalised Measurement Values N_{g,n,s} all have the same units, range and linearity so that they can be compared with other normalised measurements in the same group #g. The Threshold Confidence TC_{g,n,s} is a unitless value ranging from 0 to some maximum value TCmax that expresses the confidence that a measurement N_{g,n,s} passed a threshold value TV_{g,s}. Because TC_{g,n,s} has been generated as a linear value with a defined range and no units, it can be compared and manipulated with dissimilar measurements from different groups. Importantly, use of the instrument TC_{g,n,s} allows more accurate QC results to be obtained in a QC process by propagation and aggregation of TC_{g,n,s} from measurements that could otherwise not be compared.

A worked example could be used to calculate the TC for the whitest pixel that is allowed in a picture. In an 8 bit video system, black pixels have the value 16 and white pixels have the value 235. Checking the white value constitutes a Measurement Value with no intrinsic measurement error where the threshold Value TV_{g,s} is a maximal threshold (235), one way to calculate the Threshold Confidence TC_{g,n,s} would be to calculate the percentage distance of the Normalised Measurement in the Latitude window (values 233-237):
TC_{g,n,s}=100% for all N_{g,n,s}<TV_{g,s}−L_{g,s} [symbol] i.e. less than 233
TC_{g,n,s}=0% for all N_{g,n,s}>TV_{g,s}+L_{g,s} [symbol] i.e. greater than 237
TC_{g,n,s}=(N_{g,n,s}−TV_{g,s})/2L_{g,s} for all other values of N_{g,n,s} i.e. a linear percentage of the distance the measurement lies from the edges of the threshold.

This is shown in FIG. 2, where both normalised measures are above (TV_{B}+L_{B}) and they would therefore have a TC value of 0%—corresponding to a fail.

The Threshold Confidence, however, becomes more complicated due to the fact that many measurements (such as blockiness) are intrinsically inaccurate and subjective. Others (such as loudness) use Normalised Measurement units that are non-linear in nature. To compensate for this, an Error Bar function is introduced to allow for a window of possible values that might have been made by a given tool. In general, the Error Bar function will be a simple linear multiplier, but may be more complex for some measurement groups, such as blockiness, where other picture detail may be taken into account.

The Error Bar Function is shown pictorially in FIG. 2 as an I beam centred around the measurement value. Once the Error Bar has been taken into account it can be seen that there is a chance that the first measure M_{B,X,0} might actually have passed, whereas M_{B,Y,1} is still a definite fail.

For the remaining examples in this text, we will use the abstract function Cg to create a Threshold Confidence value TC_{g,n,s} for measurement group #g. This function is different for each measurement group and takes into account differences in output between different measurement tools of the same measurement group as well as its intrinsic error properties when generating TC.

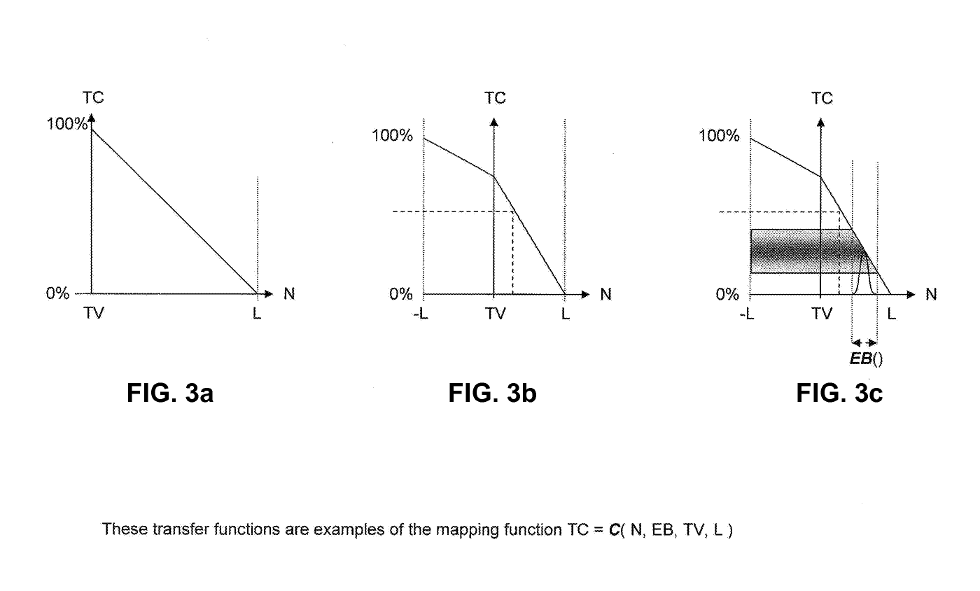

FIGS. 3a-3c illustrate different levels of complexity in the function C_{g}. FIG. 3a shows the simplest example for a measure with a maximal TV. It shows the mapping outlined in the text above where the TC is a linear representation of the distance that N_{g,n,s} is from TV_{g,s}.

TC_{n,g,s}=Cg(N_{g,n,s}, EB_{g,n,s}, TV_{g,s}, L_{g,s})

FIG. 3b shows a more realistic mapping function C_{g} that takes into account the fact that the TV_{g,s} threshold is not symmetrical and that values of N that are less than the TV_{g,s} are not 100% certain to be passes due to the fact that the TV_{g,s} is a somewhat arbitrary number such as would be the case for a blockiness threshold.

FIG. 3c shows the effect of the EB_{g,n,s( )} function. It has the effect of adding a non-linear transfer function around the actual value of N.

This unitless measure of threshold confidence for a measurement may now be compared with other TC_{g,n,s} values from different groups #g made with different tools #n to give an overall confidence that material has passed or failed at any stage #s in its lifecycle. The TC_{g,n,s} value also acts as a parameter for allowing an override confidence to auto-propagate from an earlier stage of a Quality Control process to a latter stage of a Quality Control process.

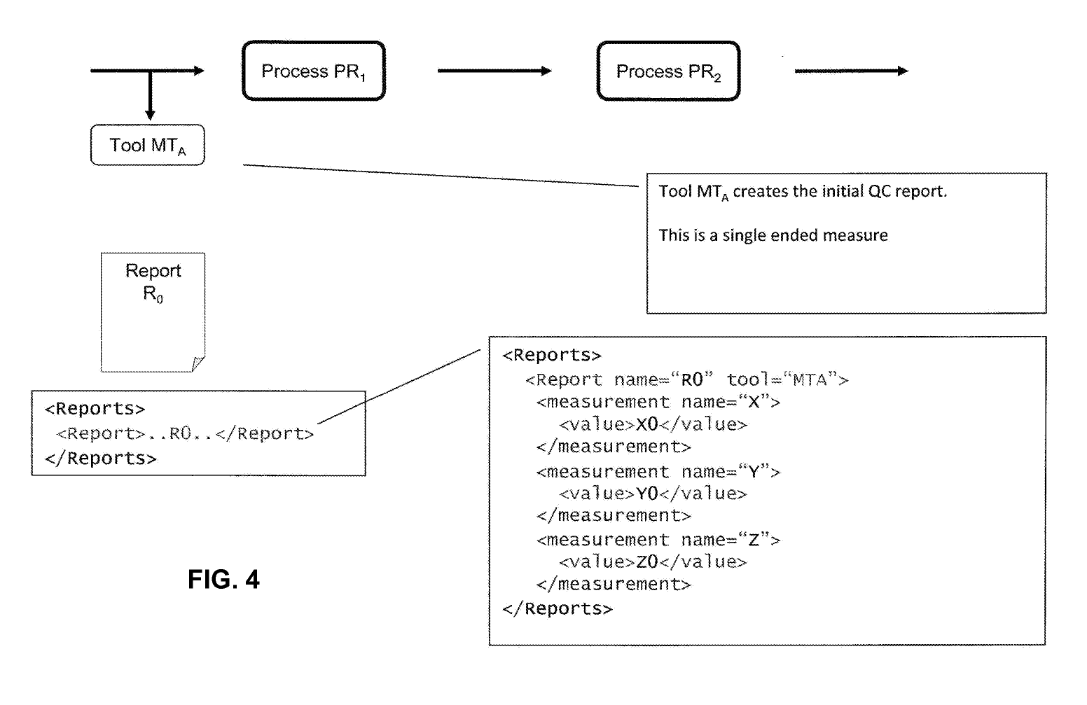

An example of the process for using these values is given in FIG. 4. This shows two processes (Process PR₁ and Process PR₂) operating sequentially on the same audio-video content. The first step is to perform a set of measurements on the incoming content and to create Report R₀. This report contains the results from Tool MTA that generates three measurements in groups X, Y, and Z to provide Measurement Values M_{X,A,0}, M_{Y,A,0} and M_{Z,A,0}. Tool MTA can be regarded as producing the initial QC report. It is, of course, a single ended measure.

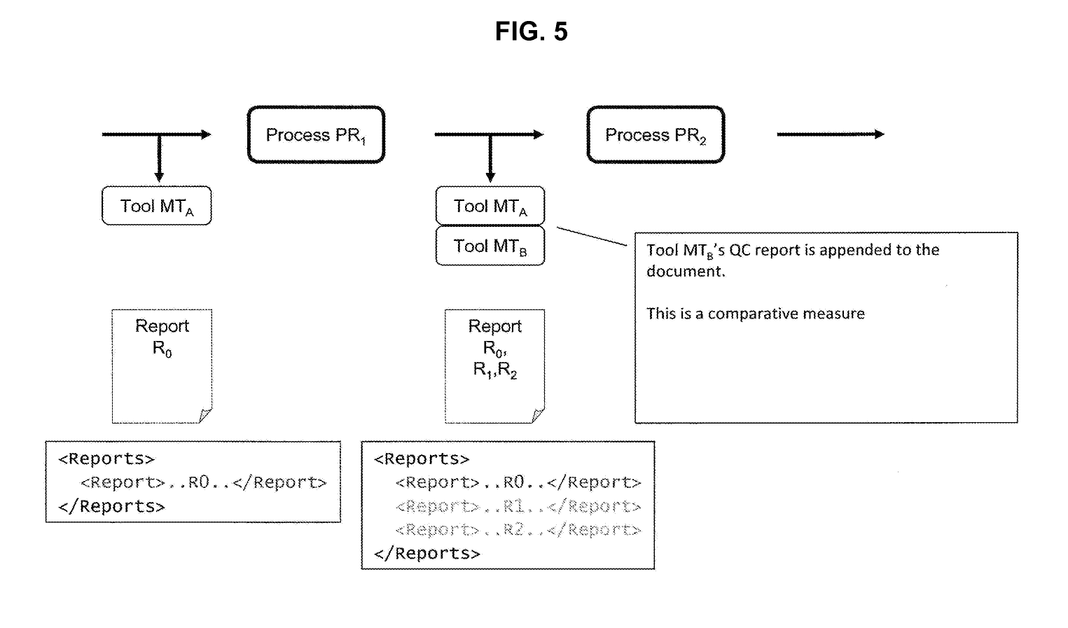

After processing the media in Process PR₁ the output media is tested again, as shown in FIG. 5. In this case, two tools are used. Tool MT_{A} is used to create Report R₁ and Tool MT_{B} is used to create Report R₂. For the case of Tool MT_{A} the same three measurement techniques are used to create new Measurement Values M_{X,A,1}, M_{Y,A,1} and M_{Z,A,1}. Tool MT_{A} can perform a comparative or double ended measure. Tool MT_{A}'s new QC report and Tool MT_{B}'s QC are appended to the original QC report R₀.

After processing the media in Process PR₂, the output media is tested again. In this case three tools are used. Tool MT_{A} is used to create Report R₃, Tool MT_{C} is used to create Report R₄ and Tool MT_{D} is used to create Report R₅. For the case of Tool MT_{A} the same three measurements techniques are used to create new Measurement Values M_{X,A,3}, M_{Y,A,3} and M_{Z,A,3}.

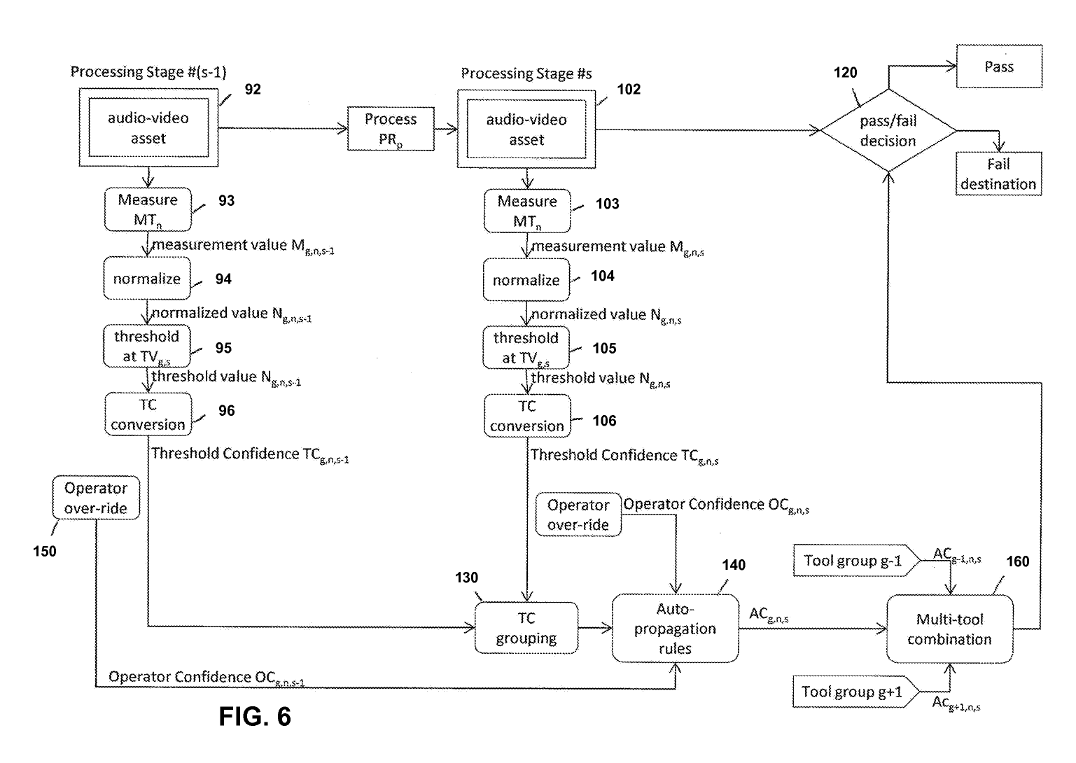

It is helpful here to refer to FIG. 6 which takes the same diagrammatic approach as FIG. 1 but illustrates measurements being taken at more than one process stage. A Threshold Confidence provided by the measurement tool 93 operating on content prior to the process PRₚ (with processing blocks 93 to 96) is grouped with the current Threshold Confidence in TC Grouping block 130.

FIG. 6 also shows an auto-propagation block 140 which also receives an operator over-ride input from block 150 and a multi-tool combination block 160, the functionality of which will be described in more detail below.

To exemplify comparison between the same tool from the same group at difference stages, measurements from group X are first normalized with a measurement specific process as follows:

N_{X,A,1}=f_{X}(M_{X,A,1})

N_{X,A,2}=f_{X}(M_{X,A,2})

N_{X,A,3}=f_{X}(M_{X,A,3})

The next step is to introduce Threshold Confidence using the measurement specific mapping function Cg.

TC_{X,A,1}=Cg(N_{X,A,1}, EB_{X,A,1}, TV_{X,1}, L_{X,1})

TC_{X,A,2}=Cg(N_{X,A,2}, EB_{X,A,2}, TV_{X,2}, L_{X,2})

TC_{X,A,3}=Cg(N_{X,A,3}, EB_{X,A,3}, TV_{X,3}, L_{X,3})

Typically the resulting values of TC_{g,n,s} will correspond to some business indicator:
Pass/Fail—for processes that have simple rejection workflows (TC greater than some threshold)
Pass/Warn/Fail—For more complex procedure where a supervisor might be required to judge rework on an intermediate state. For example
Pass TC>66%
Warn TC>33% and TC<=66%
Fail TC<=33%

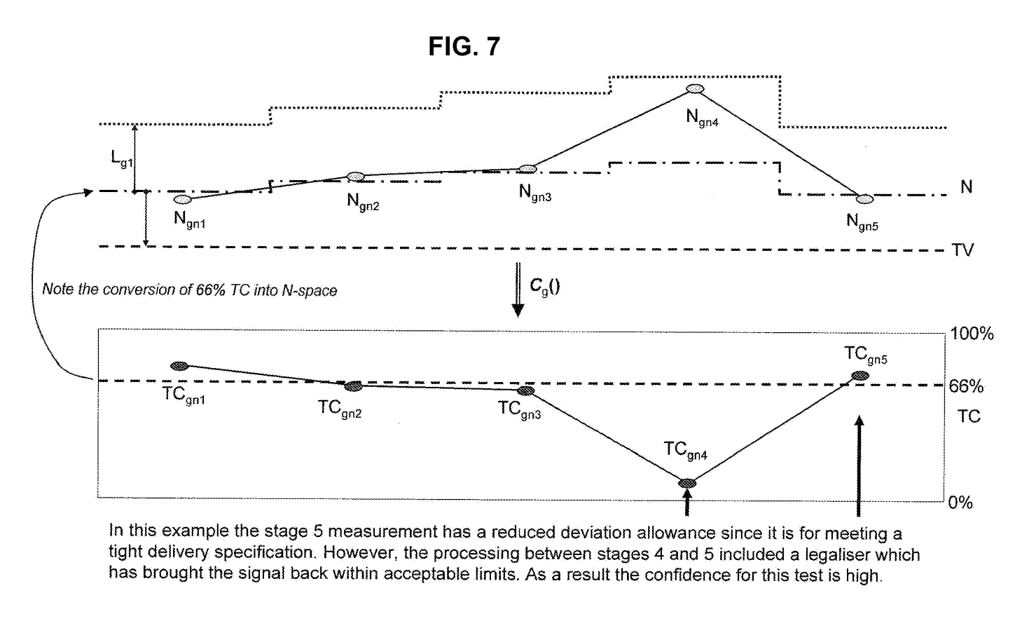

FIG. 7 shows five stages of measurement of an abstract value N and shows the mapping of those values of N into TC. Note that the (somewhat arbitrary) setting of a pass to be 66% maps back into N space as a staggered line represented by the dash-dot central line.

The present invention introduces the concept of threshold confidence where, for example, a continuous value from 0% to 100% is introduced that allows any measure to have a continuous scale of confidence that the measure has passed the test.
The value 100% corresponds to absolute certainty that a particular measure has passed a test.
The value 0% corresponds to absolute certainty that a particular measure has failed a test.
Any value between 0% and 100% gives the confidence with which a measure has passed the test.

Threshold Confidence varies according to the measurement being carried out. Here are some examples:

1. “Sub-blacks” and “Supra Whites”. These measures correspond to

Luminance values of a TV signal that have exceeded the legal values from a Rec.601 video signal. The thresholds are 16 and 235 for 8 bit video. A value of 15 or 236 would be given a TC of 0% whereas a value of 17 or 234 would be given a TC of 100%. A value of 16 or 235 would be very, very close to failure without actually failing. Operationally, this would be given a TC of around 60% to indicate that it was very close to a failure threshold.

2. “Loudness” measurements are a single floating point value that indicates a modified mean loudness over a whole media clip. If this modified mean loudness exceeds a given threshold then it is a clear fail and would be allocated a TC of 0%. If the mean was less than the legal threshold mandated by either the government regulator or broadcaster. Then a TC value of 100% some_function(spread(loudness), safety_margin) would be allocated. The closer that the mean was to the threshold, then the lower the TC. If the spread of loudness values was very large, then this increases the uncertainty that the mean loudness is truly representative of the clip, reducing the confidence again.

3. “Blockiness” measurements are often a single floating point value that represent the perceived worst blockiness in a clip. The TC value can be set according to an overall blockiness measure and a ratio of how detailed the imagery in the clip was, when the blockiness measure was high. The more detailed the video content, the less visible that blockiness can be.

Threshold Confidence on its own is a useful, new concept that considerably strengthens the use in a system of automated QC measures.

It is however in the nature of many audio or video applications that the creation of interesting and entertaining content pushes the media in unexpected directions. These unexpected departures from what previously had been regarded as normal may be interpreted by automated QC measures as failures. It is also the case that, however well designed the automated QC measures, a skilled operator may reach a different and better conclusion. For example, the enormous variation in styles and genre of video content passing through a typical delivery channel, makes it very difficult for an automated QC measure to distinguish reliably between what an end user would perceive as acceptable and unacceptable departures from a perhaps arbitrary measurement threshold.

In a QC workflow according to the embodiment shown in FIG. 6, a human operator can optionally override the results of an automatic tool. An operator can for example take a result that was deemed to be a failure by the automatic tool and reclassify it as a pass by assigning an Override Confidence value.

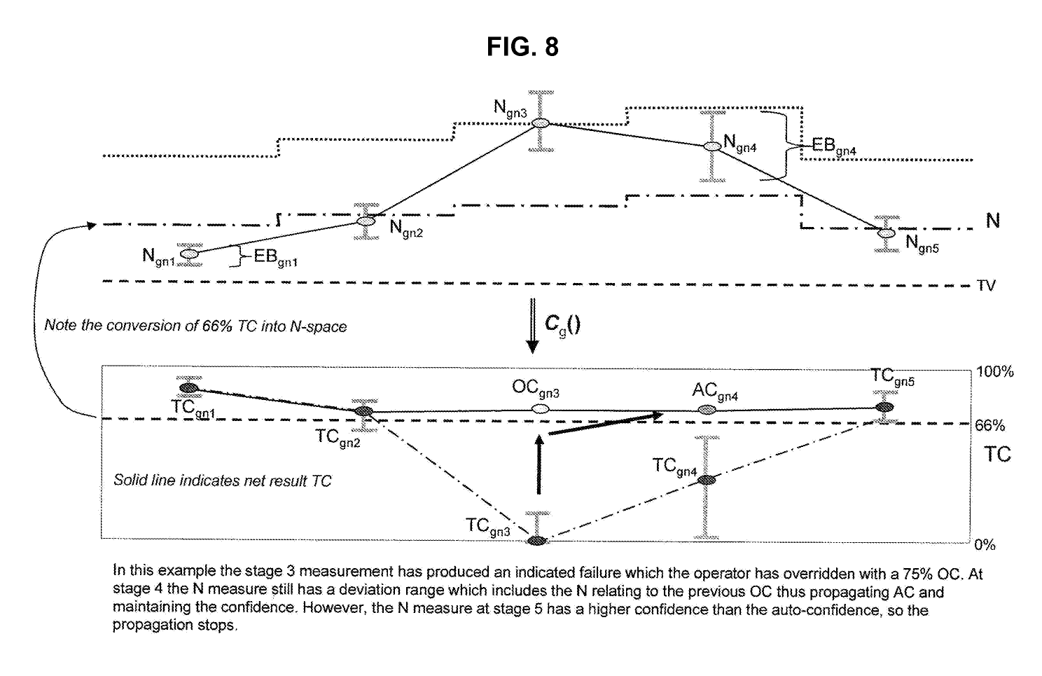

FIG. 8 shows an example where an operator decided that the measurement at stage 3 was not, in fact, an error, but was a pass. The operator was around 70% confident that it was a pass and this value OC_{g,n,s} is now taken as the new threshold confidence for that particular measurement. The calculated TC_{g,n,s} has been overridden.

If an operator overrides the value of a measurement, then all user interaction (GUI, reports etc.) will display the Override Confidence rather than the Threshold Confidence. Override Confidence uses the same scale as TC and indicates how confident the operator was that the measurement was a pass. In many cases operational staff will only ascribe values of 0% or 100%.

For some measurements where human judgement is vital (such as a blockiness measure), the operator would be presented with a user interface to allow them to give a true OC value between 0% and 100%. This allows the operator to give a value that represents “how close to being fit for purpose” the media clip is. This threshold will vary based on the value of the material and the target to which the material is being sent. Operators are trained to make these judgements.

A rule for automatic propagation of Override Confidence OC_{g,n,s} is based on the normalized measures and normalized confidences. FIG. 8 shows an example where an operator overrode the TC of measurement 3, and there is applied the rule “If the measurements are still consistent then propagate the override confidence automatically”. This method has the advantage that a single override can be used automatically in several stages of the lifecycle of the material.

To allow Auto-propagation, it is desirable to define the word “consistent”. There is scope for tuning these rules for each specific measurement, but a useful basic rule is that if the TC is the same or better (higher or lower depending on the nature of the threshold) than the previous stage then flag it as a valid override. Whether or not the override is actually propagated may be determined by the product configuration to maximise flexibility.

As a worked example the False-Negative override case (OC_{g,n,s}>TC_{g,n,s})—FIG. 8 may be auto-propagated with the following sample rules:

If [((TC_{g,n,s}>=TC_{g,n,s}−1) or (N_{g,n,s}−1 falls within EB_{g,n,s}(N_{g,n,s})))=and (OC_{g,n,s}−1>TC_{g,n,s}−1)] then AC_{g,n,s}=OC_{g,n,s}−1 i.e. if the TC is the same or higher than the previous stage then flag it as a valid override.

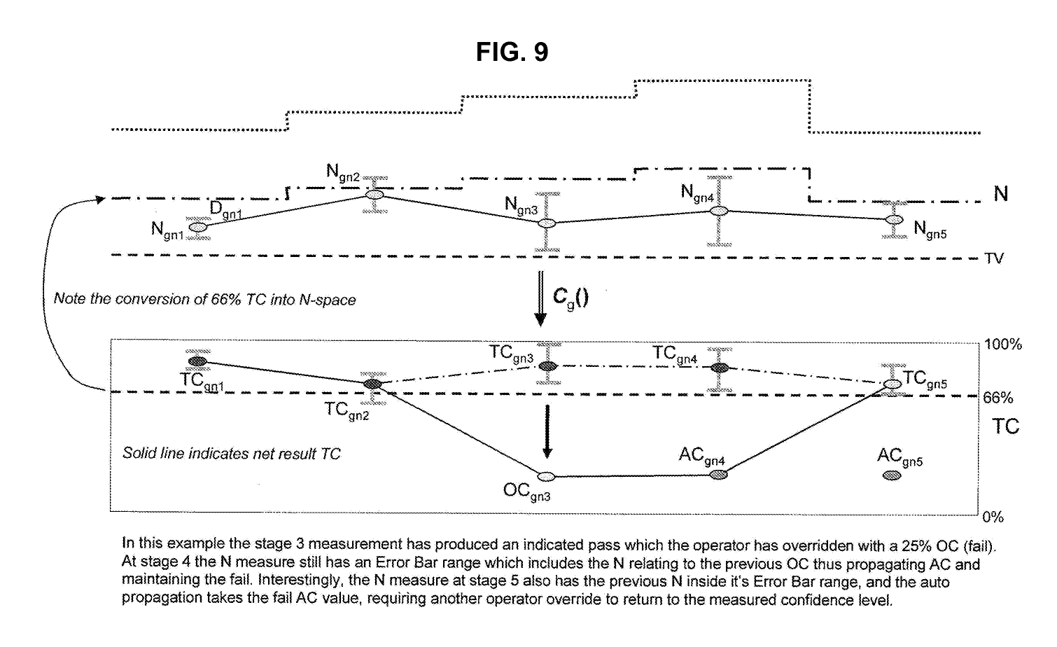

False-Positive override case (OC_{g,n,s}<TC_{g,n,s})—FIG. 9:

If [((TC_{g,n,s}<=TC_{g,n,s}−1) or (N_{g,n,s}−1 falls within EB_{g,n,s}(N_{g,n,s}))) and (OC_{g,n,s}−1<TC_{g,n,s}−1)] then AC_{g,n,s}=OC_{g,n,s}−1 i.e. if the TC is the same or lower then flag it as a valid override.

An enhancement to these basic sample rules is to look back over all previous stages and not just the most recent stage. This would create a control that would allow “auto-propagate overrides from any previous stage”.

A further enhancement is to provide that, if the first rule is not met, but there is an overlap between the TC error bars of the current stage and the TC error bars of the stage where the override was created, then this should be flagged as “likely to be a valid override”. This catches the case where it is difficult to ascertain that the error bars were either masking a bad value or degrading a good value.

When the auto-propagation rules are applied and there exists an Override-Confidence, there can be up to 3 confidence values. They are applied in this order of precedence:

1. OCg,n,s—this is used if it exists

2. ACg,n,s—this is used if it exists and the business rules allow

3. TCg,n,s—the default value of threshold confidence for this measure

Using this simple rule and this methodology, operator actions can be rapidly and automatically applied to many different tools taking into account their inherent differences and algorithms.

### Multi-Stage, Single-Tool UQC

Using the same methodology as above, but looking across difference stages of a group of measurements, the same rules can be applied to propagate an upstream decision of an operator to a downstream measurements and gives the ability to propagate judgements in an environment where allowances are made for the uncertainty of the underlying measures.
When an identical measure is used at different stages of the lifecycle, the Latitude L_{g,s} may be derived from an upstream stage L_{g,s-1} to reflect business rules. For example
“Sub Blacks” and “Supra Whites”—The final value of L_{g,s} would be set 0% for broadcast delivery because there is no tolerance allowed in this measure for final delivery. Upstream, however, the value could be set to a relatively large value like 5% because moderate excursions during the signal processing path can lead to improved image quality.
“Loudness”—The final value of L_{g,s} for broadcasting would be set to a very small value because there are strict rules for Loudness in a broadcasting chain, whereas for internet delivery L_{g,s} would be set to a high value on the grounds that there are few loudness requirements and the listening environment is very different to broadcast.
“Blockiness”—The final value of L_{g,s} would be increased (e.g. L_{g,s}=2×L_{g,s-1}) at the final delivery because a small amount of blockiness is often tolerated at final delivery, whereas blockiness is rarely tolerated upstream during the program creation process.

### Multi-stage, Single Tool, Reworked QC

The methodology can also be used in conjunction with propagated upstream measurements and decisions where an adjustment rework operation is performed to either improve on a failing measure, or to ensure acceptance of the result within a tighter specification. This continuation of the lifecycle has the added advantage of automatically verifying that repeated application of the original measurements produce results within the expected Latitude range, i.e. that fixing problem A has not created a problem B.

Overrides in this case may be created, not just by operators, but also from stored knowledge about the content. For example a low chroma detector can be automatically overridden if it is known that certain portions of the content are in black and white rather than in colour.

### Multi-Stage, Multi-Tool

The rules and values can be applied without change to multiple tools at multiple stages.

FIGS. 8 and 9 could also apply to the use of different tools (with the “n” subscript changed for a different subscript as appropriate). Using this aspect of the present invention, different tools can now be compared in a way that was not previously possible.

The described methodology allows the threshold for individual QC measurements to remain independent whilst simultaneously being able to combine and weight dissimilar measurements types to give an overall confidence that media is of acceptable quality for an application. Typically the thresholds for a given measurement will be determined by one or all of the following drivers:
Hard limits determined by some delivery specification e.g. Black level of 16 in an 8 bit system
Hard limits determined by some Service Level agreement e.g., exactly 5 minutes of black frames every 25 minutes.
Hard limits determined by a specification that gives variable results depending on start point or measurement window, e.g. program should have a loudness of −24 dB
Soft limits determined by some subjective criteria, e.g., no visible blocking
Soft limits determined by some performance criteria such as the complexity of a bitstream and the likelihood of some parameters to cause a decoder to fail e.g. too many large motion vectors, very long runs of zero bytes or motion vectors that cause off-screen image information to be fetched.

No single measurement may cause a piece of material to fail, but the described methods can be used to show that the overall confidence of a pass may be very low.

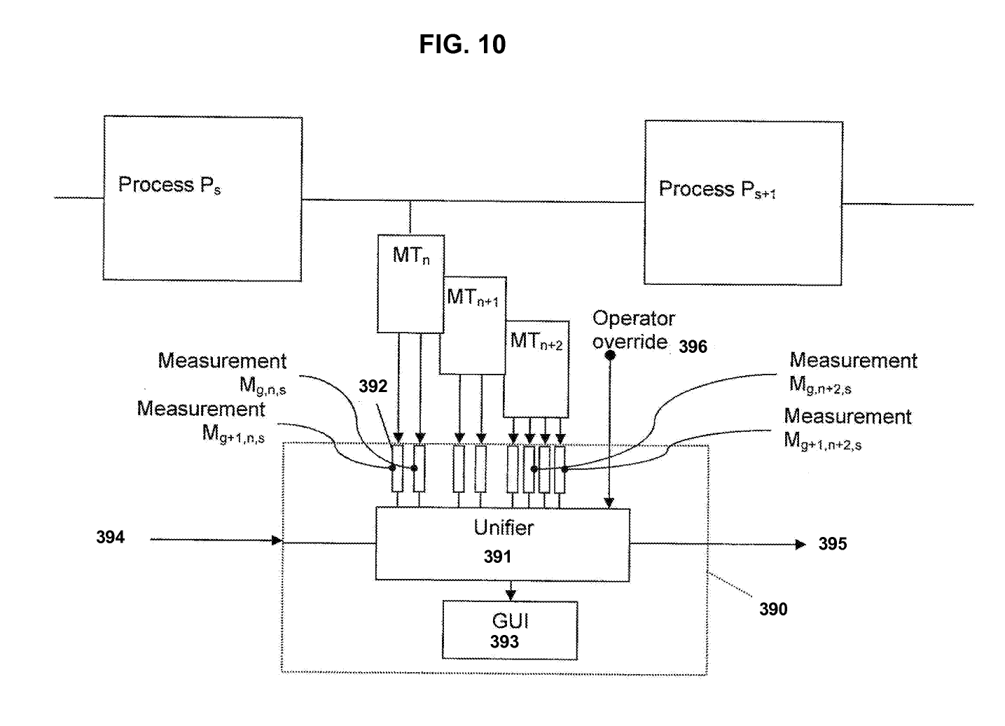

As illustrated in FIG. 10, a platform 390 is provided between two process stages, with like platforms being provided between other process stages. Preferably, a platform is provided before or after each significant process or collection of processes in a process chain.

Often, a platform will be provided at the point of first receipt of content by a commercial entity within a chain or group of entities working together in the creation; post-production; repurposing or other processing (where appropriate) and delivery of content. In that case, a threshold confidence value can determine whether or not content is accepted and/or whether content is stored or not.

Platform 390 comprises a unifier block 391 which communicates with the various measurement tools through respective measurement tool interfaces 392. There is also provided a graphical user interface. Inputs 394 and 395 communicate with upstream and downstream platforms. An operator override 396 is also provided. Operation of the platform will be understood from the foregoing description.

Separation of the measurement tool interfaces 392 from the unifier block 391 simplifies the extension of the platform to work with new proprietary measurement tools.

The GUI will preferably take advantage of the linear, dimensionless nature of the threshold confidence to provide absolute or relative indications of quality which can be interpreted instantly, even by non-specialists. These may take the form of simple bars, although the linear nature can still be maintained with curved lines. In the typical case, where the range of threshold confidence values is divided into pass and fail ranges or pass, warn and fail ranges, the simplicity of the interface can be maintained by changing the colour of the linear bar (curved of straight) to signify movement from one range to the next. The colours green, yellow and red can conveniently be employed for the pass, warn and fail ranges, respectively.

Content which has a threshold confidence value in the warn range can be treated in various ways. It may be appropriate automatically to divert any such content to reworking station where (usually) human operators can attempt to improve the quality. If the reworking resources are limited, the actual threshold confidence values can be used to rank the content to provide a priority order for reworking.

It will be understood that the process chain has been depicted symbolically and “adjacent” processes may actually be widely separated geographically and in time. It will be convenient to transport the reports which have been described above, in the form of metadata associated with the audio-video content.

The platform may take the form of software only, in a case where appropriate general purpose hardware already exists with the appropriate connectivity. Hardware/software hybrids or wholly hardware solutions are of course also possible.

Having thus described a preferred embodiment, it should be apparent to those skilled in the art that certain advantages of the described method and apparatus have been achieved.

It should also be appreciated that various modifications, adaptations and alternative embodiments thereof may be made within the scope and spirit of the present invention. The invention is further defined by the following claims.

What is claimed is:

1. Apparatus for monitoring the quality of an audio-video process chain comprising a plurality of processes operating in stages on audio-video content, the apparatus comprising:
a plurality of measurement tool interfaces for connection with measurement tools to receive measurements; and
a confidence threshold processor for converting each measurement to a threshold confidence;
wherein the confidence threshold processor receives each measurement, a threshold value of acceptability, a latitude of acceptability relating to the threshold, and an error function relating to a reliability of the measurement;
the confidence threshold processor being configured such that the threshold confidence extends linearly between a value denoting a certainty of acceptability and a value denoting a certainty of unacceptability.

2. The apparatus of claim 1, further comprising a graphical user interface including a linear graphical representation of each threshold confidence.

3. The apparatus of claim 1, further comprising an operator override input enabling an operator viewing the audio-video content to input an Override Confidence to override the threshold confidence.

4. The apparatus of claim 1, wherein the plurality of measurement tool interfaces comprises:
a first measurement tool interface at a first process stage, configured to receive at least a first audio-video content measurement from a first measurement tool;
a second measurement tool interface at a second process stage configured to receive at least a second audio-video content measurement from a second measurement tool;
an operator override unit provided at least at the first process stage enabling an operator viewing the audio-video content to override the first measurement with a first operator override; and
an automatic override provided at least at the first process stage, automatically overriding the second measurement with the first operator override if the second measurement range overlaps the first measurement or overlaps the first operator override.

5. A method of controlling an audio-video process chain comprising a plurality of processes operating in stages on audio-video content, the method comprising the steps of:
taking in, using respective measurement tools, a plurality of measurements;
in a processor, converting each measurement to a threshold confidence by normalizing where required and comparing with a threshold value of acceptability taking into account the latitude of acceptability associated with that threshold and an error function relating to the reliability of the measurement, such that the threshold confidence extends linearly between a value denoting certainty of acceptability and a value denoting certainty of unacceptability;
defining pass and fail ranges of values of the threshold confidence;
storing for delivery or further processing audio-video content having a threshold confidence within the pass range; and
rejecting audio-video content having a threshold confidence within the fail range.

6. The method of claim 5, further comprising the steps of:
defining a warn range of values of the threshold confidence, the warn range lying between and being contiguous with the pass and fail ranges: and
diverting for reworking audio-video content having a threshold confidence within the warn range.

7. The method of claim 5, further comprising the steps of:
providing at a first process stage for an operator viewing the audio-video content to input an override confidence to override the threshold confidence; and
at a second subsequent process stage, electing automatically whether to override the threshold confidence with the previous override confidence based on the second stage measurement.

8. The method of claim 7, wherein in the case of an operator inputting an override confidence the overridden threshold confidence and, preferably, its associated normalised measurement value are made available in subsequent process stages.

9. The method of claim 5, wherein a threshold confidence TC_{g,n,s}, where #g denotes the measurement group, #n denotes the measurement tool employed in taking the measurement and #s denotes the processing stage at which the measurement is taken is derived according to:
TC_{g,n,s}=Cg(N_{g,n,s}, EB_{g,n,s}, TV_{g,s}, L_{g,s})
where N_{g,n,s} is a normalised measurement, EB_{g,n,s} is an error function, TV_{g,s} is a threshold value, L_{g,s} is a latitude of acceptability value and Cg is a confidence mapping function.

10. The method of claim 5, wherein the latitude of acceptability value varies between process stages.

11. The method of claim 5, wherein threshold confidence values for all tools in the same measurement group are aggregated at each process stage.

12. The method of claim 5, wherein the step of taking a plurality of measurements comprises taking at least a first measurement at a first process stage and at least a second measurement at a second process stage measurement; further comprising the steps of:
providing at a first process stage for an operator viewing the audio-video content to override the first measure with a first operator override; and
at a second subsequent process stage, automatically overriding the second measurement with the first operator override if the second measurement range overlaps the first measurement or overlaps the first operator override.

13. A non-transitory computer program product method of monitoring the quality of an audio-video process chain comprising instructions to perform the steps of claim 5.

14. The product of claim 13, further comprising providing at a first process stage for an operator viewing the audio-video content to input an Override Confidence OC_{g,n,s} to override the threshold confidence TC_{g,n,s}; and, at a second subsequent process stage, electing automatically whether to override the threshold confidence TC_{g,n,s} with the previous Override Confidence OC_{g,n,s} based on the second stage measurement M_{g,n,s}.

15. The product of claim 13, wherein in the case of an operator inputting an Override Confidence OC_{g,n,s}, the overridden threshold confidence TC_{g,n,s} and preferably its associated normalised measurement value N_{g,n,s} are made available in subsequent process stages.

16. The product of claim 13, further comprising defining a pass and fail ranges of values of the threshold confidence TC_{g,n,s} and, preferably, defining contiguous pass, warn and fail ranges of values of the threshold confidence TC_{g,n,s}.

17. The product of claim 13, wherein a collection of audio-video content is ranked in accordance with the threshold confidence TC_{g,n,s} and reworking resource is allocated to audio-video content within the collection in dependence upon the ranking.

18. The product of claim 13, wherein TC_{g,n,s} is derived according to:
TC_{g,n,s}=Cg(N_{g,n,s}, EB_{g,n,s}, TV_{g,s}, L_{g,s})
where N_{g,n,s} is a normalised measurement, TV_{g,s} is a threshold value and Cg is a confidence mapping function and EB_{g,n,s} is an error function.

19. The product of claim 13, wherein the latitude L_{g,s} varies between process stages.

20. The product of claim 13, wherein threshold confidence TC_{g,n,s} values for all tools in the same measurement group are aggregated at each process stage.
